(19) United States
(12) Patent Application Publication
(10) Pub. No.: US 2005/0173267 A1
(43) Pub. Date: Aug. 11, 2005

(54) Acoustic immunosensor for detecting neurotransmitter GABA

(76) Inventors: Jitendran Muthuswamy, Chandler, AZ (US); Anhong Zhou, Logan, UT (US)

Correspondence Address: CHRISTIE, PARKER & HALE, LLP, PO BOX 7068, PASADENA, CA, 91109-7068, US

(21) Appl. No.: 10/917,910

(22) Filed: Aug. 13, 2004

Related U.S. Application Data
(60) Provisional application No. 60/495,234, filed on Aug. 13, 2003.

(51) Int. Cl. G01N 27/26

(52) U.S. Cl. 205/792; 204/403.01

(57) ABSTRACT

Acoustic impedance immunosensors are disclosed that are capable of real-time measurement of GABA in a buffer solution. Several embodiments include a bio-specific recognition layer on a quartz crystal surface, where the bio-recognition layer is formed by molecular self-assembly on a gold electrode surface. Various real time measurements can be made by examining the impedance parameters of the quartz crystal on which the bio-specific recognition layer is located as it interacts with GABA. In one embodiment, the invention includes an electrochemical cell that possesses a working electrode. The working electrode including a layer of piezoelectric material, at least one electrode layer fixed to the piezoelectric material and a bio-specific recognition layer formed on the electrode layer and including anti-GABA. In addition, an electrochemical workstation is connected to at least one electrode of the electrochemical cell and an impedance analyzer is connected to the working electrode.

### CROSS-REFERENCE TO RELATED APPLICATION

This application claims the benefit of U.S. provisional patent application No. 60/495,234, filed Aug. 13, 2003, which is hereby incorporated by reference as if set forth in full herein.

### STATEMENT REGARDING FEDERALLY SPONSORED RESEARCH OR DEVELOPMENT

Financial assistance for this project was provided by National Institute of Health Nos. IR43NS046088-01 and R21NS41681. Thus, the United States Government has certain rights to this invention.

### BACKGROUND

γ-Aminobutyric acid (GABA), as one of two main inhibitory neurotransmitters, plays an important role in mammalian central nervous systems (CNS). However, direct measurement of GABA concentrations in the brain faces several significant challenges. It is difficult to detect GABA through an enzymatic reaction because neither oxidase nor hydrogenase can be found.

There are many techniques to detect or measure the extracellular concentrations of GABA, such as liquid chromatography with electrochemical detection (LC-ECD) by pre/post-column derivatization, fluorescence, micellar electrokinetic chromatography and laser-induced fluorescence detection (MEKC-LIFD). GABA can be detected electrochemically by transferring it to electroactive derivatives using a derivatization reaction, e.g., using derivatizing reagents. But these derivatization methods are seldom used in LC-ECD since most of the derivatizing reagents are electro-reduced at relatively negative potentials. Some researchers have used microdialysates combined with capillary zone electrophoresis (CZE), and measured charged amino acids like glutamate and aspartate. Using GABA aminotransferase (GABA-T, EC 2.6.1.19) and succinic semialdehyde dehydrogenase (SSDH, EC 1.2.1.16), enzyme catalysis reactions allows for a spectrophotometric or calorimetric assay of GABA. Spectrophotometric methods are typically not continuous because the products generated by the enzymatic reaction must be separated before further analysis. Moreover, the additions of reagents (such as NADP) to sample solution will sometimes change the physiological response of nerve cells. Some researchers have measured the GABA concentration by horseradish peroxidase (HRP)-based electrochemical detection. Most of these techniques are difficult to adapt to providing real-time and on-line analysis of GABA in a biological sample.

### SUMMARY OF THE INVENTION

Embodiments of the current invention allow for real-time measurement of the neurotransmitter y-aminobutyric acid (GABA) using an acoustic impedance immunosensor. One embodiment of the invention includes a layer of piezoelectric material, at least one electrode layer fixed to the piezoelectric material and a bio-specific recognition layer formed on the electrode layer and including anti-GABA. In addition, the piezoelectric material can be a quartz crystal and the electrode layer can be constructed using gold.

A further embodiment of the invention includes an electrochemical cell, including a working electrode. The working electrode includes a layer of piezoelectric material, at least one electrode layer fixed to the piezoelectric material and a bio-specific recognition layer formed on the electrode layer and including anti-GABA. In addition, an electrochemical workstation is connected to at least one electrode of the electrochemical cell and an impedance analyzer is connected to the working electrode.

Yet another embodiment also includes a personal computer connected to the electrochemical workstation and the impedance analyzer.

One embodiment of the method of the invention includes coating a working electrode in a bio-specific recognition layer that includes anti-GABA, determining the impedance properties of the working electrode in an electrochemical cell, adding GABA to the electrochemical cell and determining the impedance properties of the working electrode in the presence of the GABA. In a further embodiment, the GABA is added to the electrochemical cell in a buffer solution.

### BRIEF DESCRIPTION OF THE DRAWINGS

FIG. 1. is a semi-schematic view of an embodiment of an acoustic immunosensor in accordance with the present invention;

FIG. 2. is a semi-schematic diagram of another embodiment of an acoustic immunosensor in accordance with the present invention;

FIG. 3A is a side view of a working electrode in accordance with the present invention;

FIG. 3B is a front view of a working electrode in accordance with the present invention;

FIG. 4. is a flow chart of a method for creating acoustic immunosensor in accordance with the present invention;

FIG. 5. is a flow chart of a method for constructing a working electrode in accordance with the present invention;

FIG. 6. is a flow chart showing a method for modifying the surface of the working electrode in accordance with the present invention;

FIG. 7. is a flow chart showing a method for applying anti-GABA to the surface of the working electrode in accordance with the present invention;

FIG. 8. is a flow chart showing a method of measuring GABA concentration using an embodiment of an acoustic immunosensor the present invention;

FIG. 9A is the Butterworth-Van Dyke equivalent circuit model of an embodiment of a working electrode in accordance with the present invention;

FIG. 9B is an equivalent circuit for the electrochemical interference in an embodiment of an acoustic immunosensor in accordance with the practice of the present invention;

FIG. 10 is a series of semi-schematic illustrations of the chemical reactions involved in preparing a working electrode in accordance with the present invention and using the working electrode to detect GABA in accordance with the present invention;

FIG. 11A is a chart showing the impedance parameters of the acoustic immunosensor as anti-GABA is added to the working electrode in accordance with the present invention;

FIG. 11B is a chart showing the impedance parameters of the working electrode during the phase indicated as phase III on FIG. 11A;

FIGS. 12A-12C are charts based on chart 11A showing the variation in individual equivalent circuit parameters with variations in resonant frequency changes;

FIG. 13A is a chart showing the impedance parameters of the acoustic immunosensor as GABA is added to the working electrode in accordance with the present invention;

FIG. 13B is a chart showing the impedance parameters of the acoustic immunosensor as 1-aspartic acid is added to the working electrode in accordance with the present invention; and

FIGS. 14A and 14B are charts showing the electrochemical characterization of an embodiment of a working electrode in accordance with the present invention.

### DETAILED DESCRIPTION OF THE INVENTION

Embodiments of acoustic impedance immunosensor in accordance with the present invention are capable of real-time measurement of GABA in buffer solution. Several embodiments include a bio-specific recognition layer on a quartz crystal surface, where the bio-specific recognition layer is formed by molecular self-assembly on a gold electrode surface. Various real time measurements can be made by examining the impedance parameters of the quartz crystal on which the bio-specific recognition layer is located as it interacts with GABA.

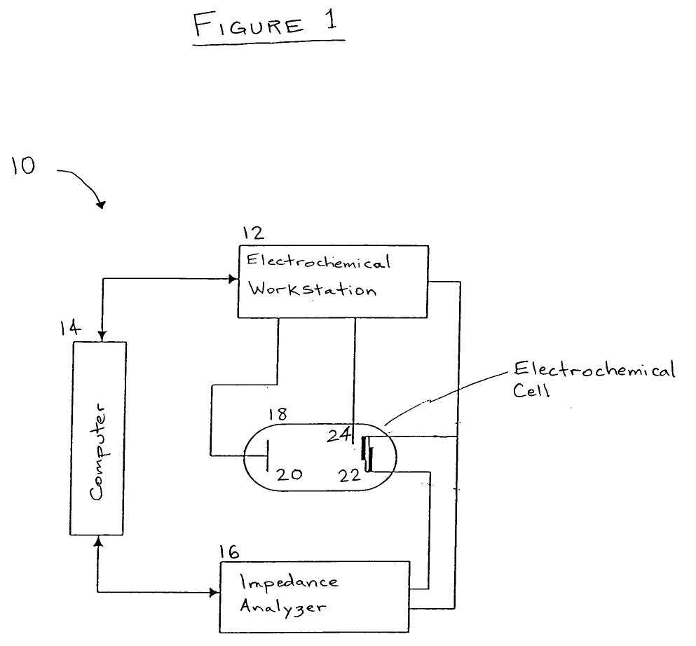

A semi-schematic view of an embodiment of an acoustic immunosensor in accordance with aspects of the present invention is shown in FIG. 1. In one embodiment, the acoustic immunosensor sensor 10 includes an electrochemical workstation 12, a computer 14, an impedance analyzer 16 and a electrochemical cell 18. The electrochemical cell 18 is a vessel that includes a reference electrode 24, a counter electrode 20 and a working electrode 22. The electrochemical workstation is connected to the counter electrode, the reference electrode, the computer and the impedance analyzer. The impedance analyzer is also connected to the working electrode and the computer. In operation, the electrochemical workstation is used to perform cyclic voltammetry and the impedance analyzer is used to perform electrochemical impedance spectroscopy.

The electrochemical workstation in combination with the three electrodes can be used to measure the current in the electrochemical cell as a function of potential. This can be achieved by measuring the current in the electrochemical cell and varying the voltage between the working electrode and the reference electrode.

The concentration of GABA in a solution placed in the electrochemical cell can change the impedance characteristics of the working electrode. The impedance characteristics include capacitance, resistance, and inductance. The impedance analyzer can be used to determine the presence and quantity of GABA contained in the solution by measuring, in real time, the impedance characteristics of the working electrode as a chemical reaction takes place.

The computer can be used to control the electrochemical workstation and the impedance analyzer individually or in conjunction with one another. The computer may also be used for data acquisition and storage purposes.

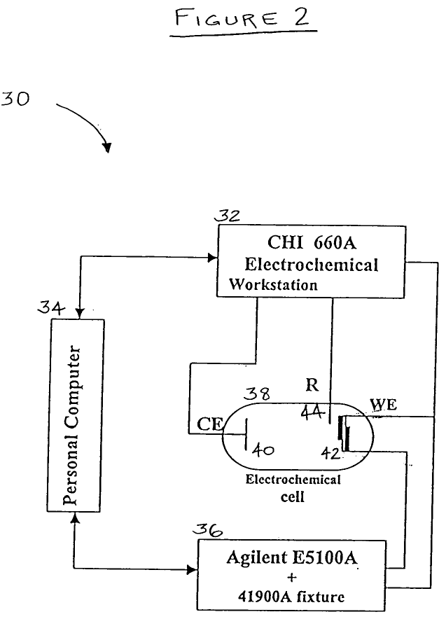

Another embodiment of an acoustic immunosensor 30 in accordance with the present invention is illustrated in FIG. 2. The acoustic immunosensor 30 includes a CHI 660 A Electrochemical Workstation 32, manufactured by CH Instruments, Inc. of Austin, Tex. The CHI 660 A Electrochemical Workstation is connected to a personal computer 34 and an Agilent E5100A with a 41900A fixture 36, which are manufactured by Agilent Technologies, Inc. of Palo Alto, Calif. The CHI 660 A Electrochemical Workstation is also connected to electrodes in an electrochemical cell 38. In one embodiment, the CHI 660 A Electrochemical Workstation is connected to the counter electrode 40 and the reference electrode 44. The personal computer is connected to the combination of the Agilent E5100A and 41900A fixture. The combined Agilent E5100A and 41900A fixture are connected to the working electrode 42 in the electrochemical cell.

In one embodiment, the counter electrode is made from platinum wire and the reference electrode is made from silver/silver chloride. In other embodiments, the counter (and reference electrode can be made from any other material that can be used as a reference or counter electrode in an electrochemical cell.

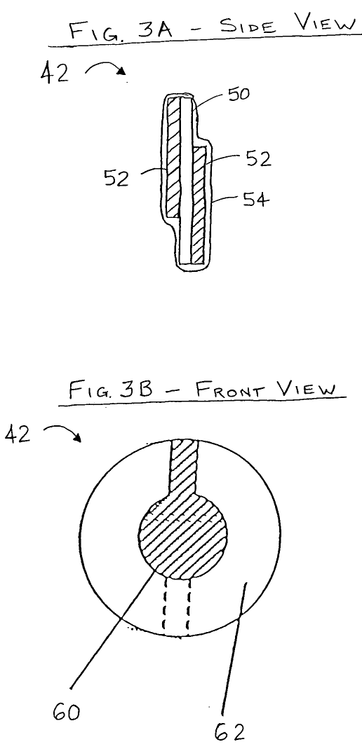

An embodiment of a working electrode in accordance with the present invention is illustrated in FIGS. 3A and 3B. The working electrode 40 includes a quartz crystal 50 that is patterned with metallic plating 52 on both sides. The quartz crystal and the gold plating are surrounded by a bio-specific recognition layer 54.

In one embodiment, the quartz crystal is a piezoelectric quartz crystal that is an AT-cut, quartz plate with a diameter of 13.7 mm, which is sandwiched between gold electrodes of diameter 7.82 mm. One side of the quartz crystal can be exposed by sealing the crystal to one side of a glass tube. In other embodiments, other piezoelectric and electrode materials can be used in the construction of the working embodiment.

In one embodiment, the bio-specific recognition layer can be formed by molecular self-assembly on the gold electrode surface. The composition and method of constructing the bio-specific recognition layer are discussed below.

In one embodiment, the electrolyte solution can be 0.1M PBS+0.5 mM K₄Fe(CN)₆+0.5 mM K₃Fe(CN)₆. In other embodiments, other electrolytes that one of ordinary skill in the art would consider to be appropriate for use in an electrochemical chemical cell in conjunction with GABA can be utilized.

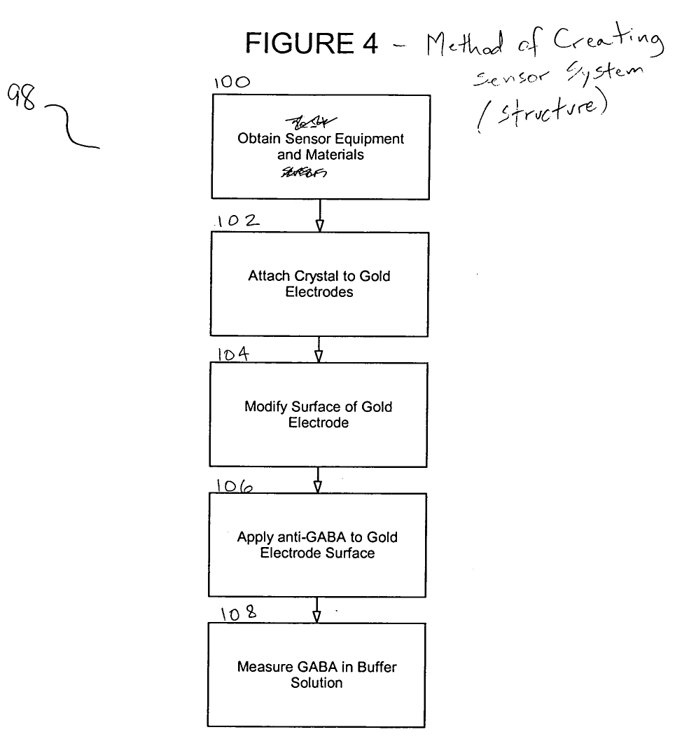

A method of constructing a working electrode in accordance with an embodiment of the present invention is illustrated in FIG. 4. The method 98 involves obtaining (100) the various components required to construct an embodiment of a working electrode in accordance with the present invention. The gold electrodes are then fixed (102) to the quartz crystal. The surfaces of the gold electrodes are modified (104). Anti-GABA is applied to the electrode surface (106) and GABA is measured (108) in a buffer solution.

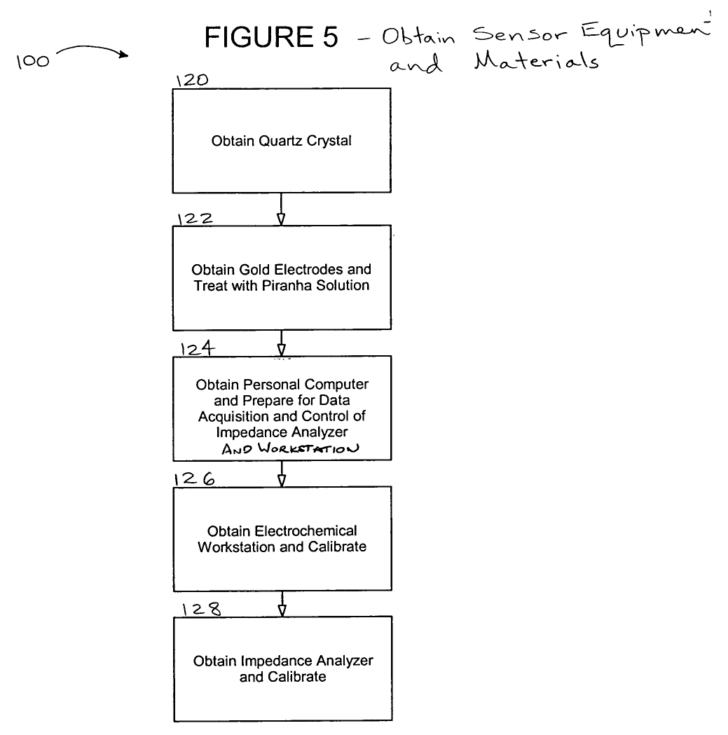

A method of preparing to construct a working electrode in accordance with the present invention is illustrated in FIG. 5. The method 100 includes obtaining (120) a quartz crystal, obtaining gold electrodes (122) and treating the gold electrodes with Piranha solution. A personal computer is obtained (124) and prepared for data acquisition and control of the impedance analyzer and workstation. An electrochemical workstation is obtained (126) and calibrated and an impedance analyzer is obtained (128) and calibrated. In one embodiment, the gold electrodes are treated (122) with Piranha solution for 5 minutes.

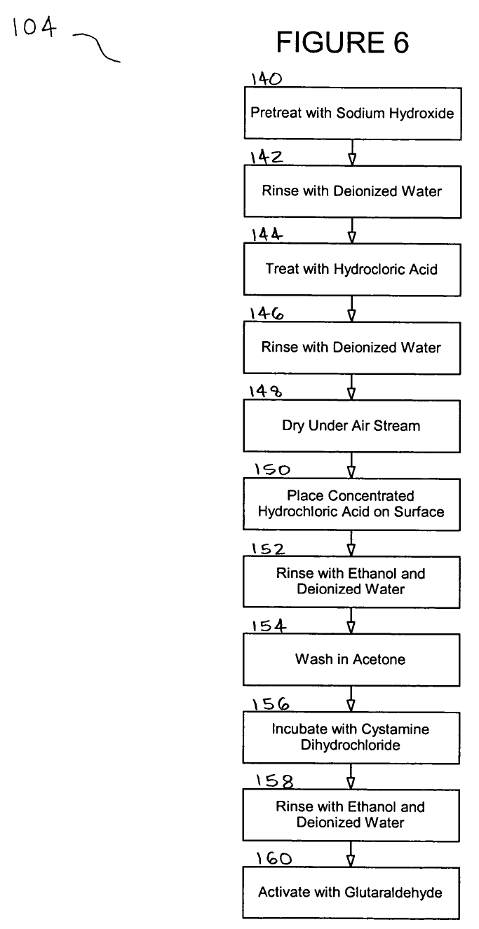

A method of modifying the surfaces of the gold electrodes in accordance with the practice of the present invention is illustrated in FIG. 6. The method 104 includes pre-treating (140) the gold electrodes with sodium hydroxide. The gold electrodes are rinsed (142) with deionized water and are treated (144) with hydrochloric acid. The electrodes are then rinsed again (146) with deionized water and dried (148) under an air stream. Concentrated hydrochloric acid is placed (150) on the surface of the electrodes and then the electrodes are rinsed (152) with ethanol and deionized water. The electrodes are then washed (154) in acetone. The electrodes are then incubated (156) with cystamine dihydrochloride. Once the electrodes have been rinsed (158) again with ethanol and deionized water, the monolayer-modified crystal is further activated (160) with glutaraldehyde.

In one embodiment, the quartz crystal to which the gold electrodes are attached are pretreated (140) by immersing them in 1.0M NaOH for 20 min, followed by rinsing (142) with deionized water. The resulting crystals are then soaked (144) in 1.0M HCl for 2 min, rinsed (146) with deionized water and dried (148) under a stream of air. Concentrated hydrochloric acid, 50 μl, is placed (150) on the gold electrode surface for 2 min. The hydrochloric acid is then rinsed (152) from the crystal with ethanol and deionized water. For covalent binding of bio-ligands, the gold surface of electrodes on the crystals are chemically activated at the beginning. The crystals washed (154) in acetone are incubated (156) with a 0.02M aqueous solution of cystamine dihydrochloride for 2 h. After washing (156) in ethanol and deionized water and drying at laboratory temperatures, the monolayer-modified crystal is further activated (160) by glutaraldehyde (2.5% in water) for 1 h.

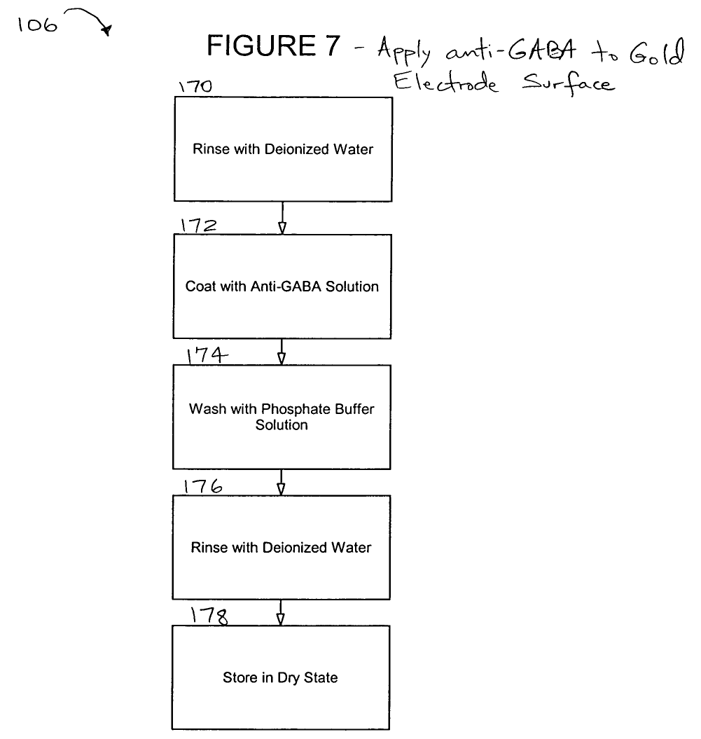

A method of applying anti-GABA to the gold electrode surface in accordance with the practice of the present invention is illustrated in FIG. 7. The method includes rinsing (170) the crystal to which the electrodes are attached with deionized water. The crystal and electrodes are then coated (172) with an anti-GABA solution. A phosphate buffer solution (174) is then washed over the crystal and electrodes, which are then rinsed (176) with deionzed water. The working electrode is then finished and stored (178) in a dry state.

In one embodiment, the quartz crystal and the electrodes affixed to it are washed (170) with deionized water. Then 20 μl of 20 μgml⁻¹ anti-GABA solution (1:100 dilution from stock solution) is spread (172) on the gold electrode surfaces of the crystal. The impedance parameters of the crystal are recorded as soon as the anti-GABA solution is added on the surface of the crystal. After being kept for 1 h and 20 min, the electrode is washed (174) with PBS (pH 7.4). After further washing (176) in deionized water and drying in air, the crystal is stored in a dry state for 10 h. Following storage, the completed working electrode is capable of use in a system in accordance with the present invention for measuring the presence of GABA.

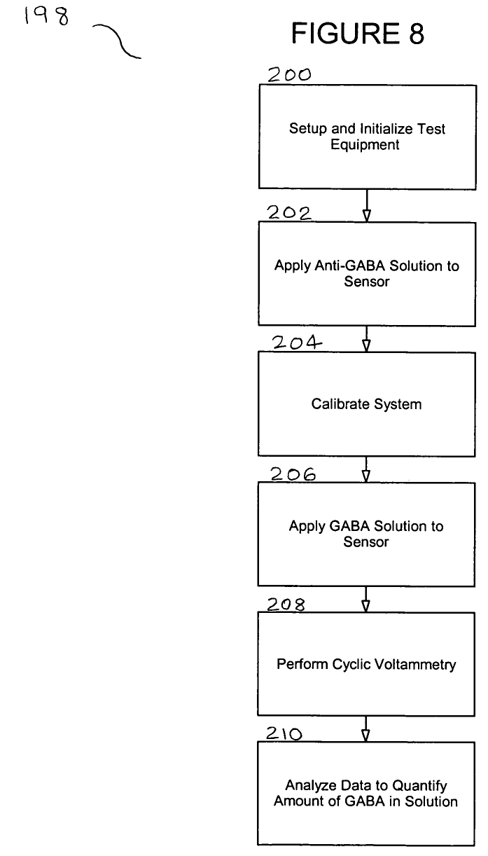

A method of measuring GABA in a solution in accordance with the practice of the present invention is illustrated in FIG. 8. The method 198 involves setting up and initializing (200) the test equipment. As part of the set-up process, an anti-GABA solution is applied (202) to the electrochemical cell and the system calibrated by determining the (204) impedance parameters. In one embodiment, the calibration of the system is performed during the construction of the working electrode (see description above). The GABA solution being measured is applied (206) to the electrochemical cell and cyclic voltammetry is performed and the impedance parameters of the working electrode are recorded (208). The data obtained is then analyzed (210) to determine the amount of GABA in the solution.

Acoustic immunosensors and methods of using the acoustic immunosensors in accordance with the present invention are discussed above. Examples of the outputs generated by acoustic immunosensors in accordance with the present invention are presented below. In order to assist in the understanding of the outputs generated by the acoustic immunosensor, the theory behind the operation of the acoustic immunosensor is described. The theory is presented only as a framework for explaining the output of the acoustic immunosensor and does not in any way limit the inventions described herein.

Piezoelectric mass detection is based on the linear relationship between the resonant frequency changes (Δf) of a piezoelectric quartz crystal and mass changes (Δm) on its surface as described by the Sauerbrey equation:

$$Δ f = \frac{2 {f}_{0}^{2}}{{( {ρ}_{Q} {μ}_{Q} )}^{1 / 2}} \frac{Δ m}{A} \qquad ( 1 )$$

where f₀ is the fundamental frequency, A is the geometric surface area of the piezoelectric crystal, μ_{Q} and ρ_{Q} are the shear modulus and density of the quartz, respectively.

This simple oscillator method is an excellent choice for measuring mass changes in rigid films but is impacted by several constraints while measuring non-rigid films. It has been found that changes in the physico-chemical properties and/or changes of the contacting materials/media will result in frequency changes of the quartz crystal when it is used in liquid phase. For example, the effect of density (ρ_{L}) and viscosity (η_{L}) of the liquid on the resonant frequency changes is as follows:

$$Δ f = - \frac{{{f}_{0}^{3 / 2} ( {ρ}_{L} {η}_{L} )}^{1 / 2}}{{( π {ρ}_{Q} {μ}_{Q} )}^{1 / 2}} \qquad ( 2 )$$

As for static capacitance C₀, the quartz crystal is physically equivalent to a simple parallel-plate capacitor with a capacitance of:

$${C}_{0} = \frac{{K}_{0} A}{{t}_{Q}} ɛ \qquad ( 3 )$$

where K₀ is the permittivity of space, t_{Q}, is the thickness of the quartz crystal, ε is the dielectric constant of the quartz.

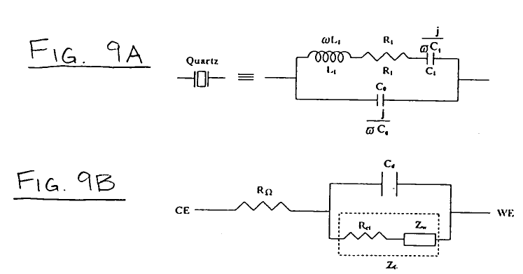

A Butterworth-Van Dyke (BVD) equivalent circuit model is shown in FIG. 9A. The equivalent circuit model is an electrical model of the quartz crystal unit when operating at a frequency of natural resonance. For a quartz crystal in a Newtonian liquid, the Martin's modified BVD model has been demonstrated as a quantitative description for simultaneous mass and liquid loading case. According to the equivalent circuit of a quartz crystal at resonance, the electrical admittance Y is given by the expression below:
Y=G+jB (4)
where G and B are the real and imaginary parts, respectively.

The phase angle of admittance, θ_{Y}, should be θ_{Y}=tan⁻¹ (B/G). The frequency fₛ, at which G is maximum (Gₘₐₓ), is given by:

$${f}_{s} = \frac{1}{2 π} {( \frac{1}{{L}_{1} {C}_{1}} )}^{1 / 2} \qquad ( 5 )$$

When applied in liquid phase, the surface of the quartz crystal will introduce dissipative energy losses in the oscillating system when used in liquid. The dissipation factor, D, is the inverse of the more well known Q-factor as shown below:

$$D = \frac{1}{Q} = \frac{{E}_{d}}{2 π {E}_{s}} = \frac{{R}_{1}}{2 π {f}_{s} {L}_{1}} = 2 π {f}_{s} {C}_{1} {R}_{1} \qquad ( 6 )$$

where Ed (related to R₁) is the energy dissipated during one period of oscillation, and Eₛ (related to fₛL₁) is the energy stored in the oscillating system. The D-factor is the sum (dimensionless) of all mechanisms that dissipate energy in the oscillatory system.

The motional resistance R₁ of the quartz crystal in a Newtonian liquid can be mathematically described as shown below:

$${R}_{1} = \frac{ω {{L}_{Q} ( 2 ω {ρ}_{L} {η}_{L} )}^{1 / 2}}{{π ( {ρ}_{Q} {μ}_{Q} )}^{1 / 2}} \qquad ( 7 )$$

where L_{Q} is the inductance of the quartz crystal in air (for example, for the quartz crystal used here, a typical value of L_{Q}=4.2 mH). In Newtonian liquid, the theoretical relationship shown below has been experimentally demonstrated:
   ΔR₁=−4πL_{Q}Δƒₛ (8)
where Δfₛ is the change of series frequency.

Similarly, we obtain:
ΔD=−8π²ƒₛC_{Q}L_{Q}Δƒₛ (9)

The theoretical slope values for ΔR₁ versus Δfₛ and ΔD versus Δfₛ are 0.053 ΩHz⁻¹ and 1.99×10.7 Hz⁻¹, respectively, for the quartz crystal used in this work. In practical measurements, it is likely that a smaller ratio of ΔR₁ versus Δfₛ (or ΔD versus Δfₛ) indicates less contribution from the “viscosity-density” effect (i.e., so called “non-mass” effect) on total frequency changes, and vice versa. Therefore, the slope of ΔR₁ versus Δfₛ and ΔD versus Δfₛ can be used to investigated the viscoelastic properties of the thin film on the quartz crystal.

The electrochemical interface can be represented by the electrolyte resistance (R_{Ω}) in series with a double capacitance (C_{d}) in parallel with the Faradic impedance (Z_{f}) (as shown in FIG. 9B). The Faradic impedance (Z_{f}) is composed of the electron transfer resistance (R_{ct}) and the Warburg impedance (Z_{w}). In the high frequency region, the electrode reaction is generally controlled by charge transfer (or kinetic step), Z_{w}=0 and Z_{f}=R_{ct}, and then the electrochemical impedance Z is given by:

$$Z = {R}_{Ω} + \frac{{R}_{ct}}{1 + {R}_{ct}^{2} {C}_{d}^{2} {ω}^{2}} - \frac{{R}_{ct}^{2} {C}_{d} ω}{1 + {R}_{ct}^{2} {C}_{d}^{2} {ω}^{2}} j = {Z}_{re} + {Z}_{im} j \qquad ( 10 )$$

where Zᵣₑ and Zᵢₘ are the real and imaginary parts of the electrochemical impedance, respectively. R_{ct} and R_{Ω} can be simply obtained from the Nyquist circle equation, one can obtain the double capacitance value C_{d} using any of the techniques that are known to one of ordinary skill in the art.

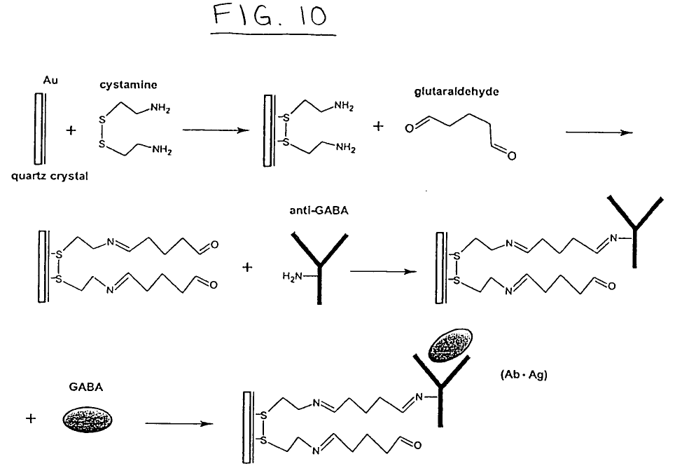

The various chemical reactions involved in creating a bio-specific recognition layer on a working electrode and in measuring GABA using the working electrode in accordance with the practice of the present invention are shown in FIG. 10.

The various chemical reactions are described above. The final equation shows the bonding of GABA to the anti-GABA within the bio-specific recognition layr. Measuring the impedance parameters of the working electrode prior to the addition of GABA and following the addition of GABA provides information concerning the amount of GABA present.

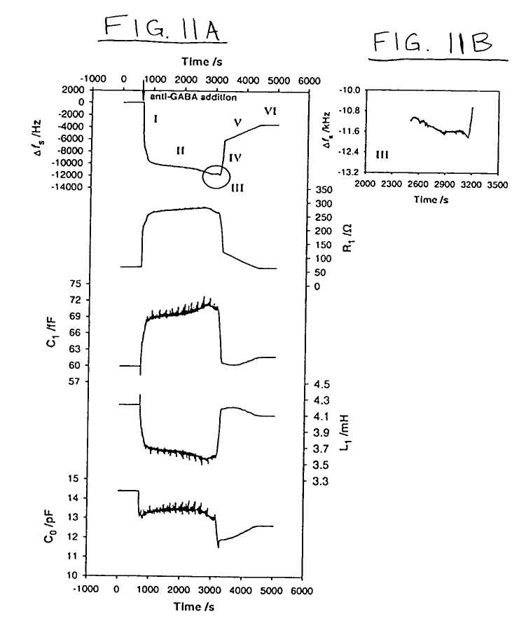

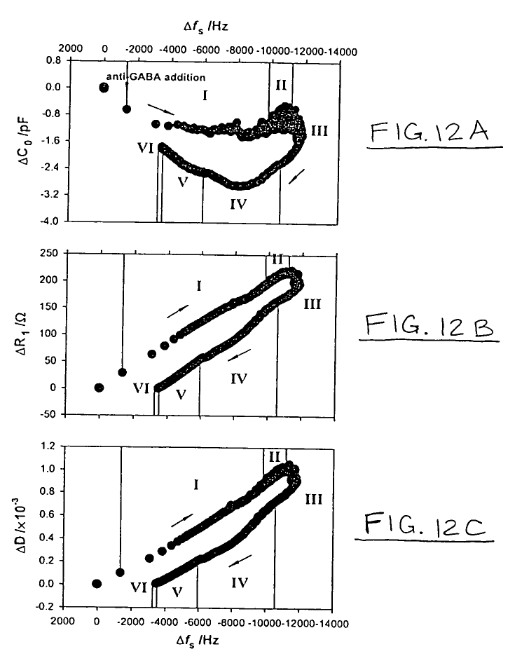

The process of calculating the impedance parameters when anti-GABA is added to the surface of the working electrode in order to calibrate the working electrode is discussed above. A chart showing the impedance parameters of a working electrode in accordance with the present invention, when an anti-GABA solution is applied to the surface of the working electrode, is shown in FIG. 11A. During measurement, non-monotonic changes in the frequency are delineated into six successive distinct periods (numbered I through VI), indicating different surface processes on the surface of the gold electrode. For example, when a 20 μl anti-GABA solution is added on the well-defined gold electrode surface of a 10 MHz quartz crystal, the series resonant frequency (fₛ) initially decreases sharply during period I (677-900 s) and then gradually decreases during period II (900-2504 s). Δfₛ shows a further decreasing trend during period III (2504-3204 s) before a sharp increase is observed during period IV (3204-3304 s). During period V (3304-4404 s), Δfₛ versus t (time) show a linear relationship until a steady state is reached during period VI (4404-5027 s). The corresponding changes in the equivalent circuit parameters are associated with changes in mass and/or viscoelastic properties during antibody immobilization on the gold surface. Water can play a critical role in the changes of surface viscoelastic properties. Each of the periods is discussed below. FIGS. 12A-12C show the individual equivalent circuit parameters vs. resonant frequency changes that are derived from the results shown in FIG. 11A.

Period I

During period I, R₁ shows an increase from 62.3 to 253.1 Ω (antibody solution uploading) within 223 s (corresponding to a decrease in Δfₛ of approximately −9730 Hz within the same time), suggesting a considerable change in viscosity-density of the boundary layer adjacent to the surface of quartz crystal. Using the estimated changes in R₁ and the theoretical slope of R₁ versus Δfₛ, the contribution of “non-mass” effect on total resonant frequency changes ((253.1−62.3)Ω/0.053 ΩHz⁻¹=3600 Hz) in this period is estimated to be 37% ((9730−3600)/9730=37%), under our experimental conditions. Due to mass loading on the gold electrode after the addition of the antibody, both Δfₛ and L₁ decrease (L₁ from 4.2 to 3.7 mH). During this same period, C₁ increases from 59.9 to 68.4 fF, while C₀ decreases from 14.1 to 13.3 pF. In period I, as soon as the antibody solution is added, this sudden mass loading on the surface of the quartz crystal leads to a sharp decrease in frequency. Meanwhile, the shear acoustic wave energy transmitted between the two electrodes of the quartz crystal is increasingly damped, i.e., energy dissipation (D) increases considerably. Increase in R₁ and D concomitant to a decrease in series resonant frequency (as shown in FIGS. 12A-12C) suggests that the acoustic energy is radiated into the contacting anti-GABA molecules. Both ΔR₁ and ΔD have a good linear relationship with Δfₛ in this period and the slope values are 0.018 ΩHz⁻¹ and 9.52×10.8 Hz⁻¹, respectively. Compared with individual theoretical values mentioned earlier, the smaller ΔR₁/Δfₛ (or ΔD/Δfₛ) ratio during period I implies that the responses of quartz crystal during the “loading” phase of the antibody solution on the gold electrode surface are primarily due to the “mass” effect as opposed to the “viscosity-density” effect or the “non-mass” effect.

Period II

During the time period II, concomitant with the decrease in Δfₛ, both R₁ and C₁ show a gradually increasing trend while L₁ is continuously decreasing. The changes in C₀ during this period are not as obvious. During this stage, the antibody droplet starts to spread out on the gold electrode surface and the water molecules begin to evaporate from the electrode surface. These two simultaneous responses can give rise to contrary effects on the frequency changes: the former resulting in a decrease in Δfₛ because more antibody molecules are deposited on the surface in terms of gravitational force, while the latter contributes to an increase in Δfₛ due to a decrease in mass. The former effect often dominates as the resonant frequency curve shows a gradual decline during time period II. Other parameters in this period change less significantly over time period II as compared to period I. This phenomenon may be explained by the following: (1) chemical kinetics involved in the formation of a bond between the amino group (—NH2) in the antibody (a protein) and the aldehyde group (—CHO) in one terminal of glutaraldehyde (the other terminal has been bound with the amino group of cystamine). This chemical bond will allow several antibody protein molecules to reside in the proximity of the gold electrode surface. Moreover, van der Waals force will facilitate the formation of the second monolayer of antibody protein on the gold surface, but this second adsorbed layer will not begin to form until the first has, for the most part, been fully occupied; (2) the microrheological changes of the protein adsorbed-layer and/or water incorporation into the proteins/polypeptide framework on the adsorbed layer; (3) the interfacial friction occurring in the droplet spreading process in this stage. Furthermore, residual moisture content beyond a monolayer increases the conformational flexibility and the ability of less tightly bound water to mobilize reactants, thereby accelerating interaction of antibody molecules with cross-linkers previously assembled on the gold surface. It is also known that protein molecules themselves show quite different adsorption behaviors on diverse hydrophobic monolayers and hydrophilic surfaces. All factors described above contribute to the energy dissipation of any shear wave penetrating into the contacting media, so R₁ and D (in FIGS. 12A-12C) increase slowly during this period. Unlike the slope of ΔR₁ versus Δfₛ, the slope value for ΔD versus Δfₛ in period II (1.10×10.7 Hz.1) is larger than that in period I, which implies more energy dissipation occurring due to the spreading processes of anti-GABA protein molecules on the quartz crystal surface in period II than that in period I. Changes in C₀ with Δfₛ in FIGS. 12A-12C indicate a lack of pronounced variation in the dielectric property of the anti-GABA solution deposited on the gold surface of the quartz crystal.

Period III

During time period III, Δfₛ continues to decrease as it did towards the end of period II (see FIG. 11B) before showing a sharp increase. However, the four equivalent elements change monotonically during this period. R₁, C₁, and C₀ show a small decrease while L₁ shows a small increase during this period. Changes in R₁ and D during time period III may be explained as follows. Variation in viscoelastic properties and morphology of the antibody protein layer adsorbed on the gold surface of the working electrode can play a significant role during this time period. Towards the end of time period II and the early stages of period III, a close-packed layer is formed on the electrode, i.e., the protein film has a tighter and tougher “shell” than in period II. The increased tightness of protein molecules causes any oscillatory motion of the surface monolayer components to be slower and more restricted. Moreover, through period II and the beginning of period III, the protein is accumulated on the gold surface and the water in bulk antibody solution is removed. The water molecules incorporated in the protein layer also begin to evaporate at this stage. Obviously, water evaporation from protein/polypeptide intermolecules is accompanied by the close-packed protein layer formation mentioned earlier. It appears that both of the above mentioned surface processes are responsible for making the protein film on gold surface more tight and rigid, resulting in less energy damping. This can explain the observed decreases in R₁ and D. Although this process also results in a decrease in series resonant frequency in the earlier stages of period III (FIG. 11A), towards the latter stages of time period, the series resonant frequency increases sharply due to water evaporation. The C₀ curve in this period also shows a similar trend as ΔR₁ and ΔD.

Period IV

During time period IV, all the circuit parameters continue the trends seen after the abrupt change towards the end of period III. A sharp increase in Δfₛ (4589 Hz) and L₁ (0.43 mH) and the rapid decrease in R₁, C₁, and C₀ (−0.109 Ω, −.7.0 fF and −.0.33 pF, respectively) are observed within 100 s. It should be pointed out that C₀ decreases first and then subsequently increases in this period (and in the next period V). As expected, during period IV, the resonant frequency is continuously increasing (see FIG. 11A), due to the rapid evaporation of inner water molecules and further tightening of protein layer. Rapid loss of water from the protein film will also lead to a decrease in R₁ observed during this period. For these low water content states, variation in the amount of internal and surface water can have pronounced effects on the protein structure and function. There is a distinct decrease in energy dissipation (decrease in R₁ and D during the drying processes of the antibody film on the gold surface). The slope values for this time are 0.025 ΩHz⁻¹ for ΔR₁ versus Δfₛ and 1.14×10⁻⁷ Hz⁻¹ for ΔD versus Δfₛ. Both values are larger than the corresponding values in periods I and II indicating more “non-mass” effect on the resonant frequency changes than in the two previous periods. It is also interesting that C₀ in this area shows an initial decrease and consequently an increase (see FIGS. 11A-11B and FIGS. 12A-12C). This can be related to changes in dielectric property of the protein layer when water continually evaporates.

Period V

During time period V, good correlation between Δfₛ and t, ΔR₁ and Δfₛ, and ΔD and Δfₛ is observed. But C₁ and C₀ are initially constant before increasing, while L₁ starts decreasing after an initial constant period. The impedance parameters change much slower during this period compared to changes in period IV (as shown in FIGS. 11A-11B). The amount of absorbed water also determines the mechanical properties of a protein. Water acts as a plasticizer, its addition (or removal) increasing (or decreasing) the free volume of protein. The drying protein layers in this period further re-arrange molecular groups and change the viscoelastic property of protein film on gold surface. The decreased water content in polypeptide framework will facilitate the formation of a more rigid and packed antibody layer on the electrode surface during period V. As a result, the energy damping or dissipation into the protein layer is lower than that observed in period IV when there was more water in the protein film. This is validated by slope values. The slope value of ΔR₁ versus Δfₛ during time period V is 0.022 ΩHz⁻¹; a little less than 0.025 ΩHz⁻¹ in period IV. Moreover, this smaller slope may suggest that more “mass” effect (on total resonant frequency change) occurs in this period compared with that in time period IV. Furthermore, the decreasing rate of water evaporation is reflected in the slope of Δfₛ versus t, 2.25 Hz s⁻¹, which is much smaller than that during time period IV (51.54 Hz s⁻¹).

Period VI

In the latter stages of period V, there is protein aggregation on the gold surface and the water in bulk antibody solution and in protein intermolecules has been removed. Therefore, the resonant frequencies as well as the impedance parameters reach a relative steady state in period VI. Compared with the baseline values in air (before antibody addition on the gold surface), the changes of four circuit elements during this period (also in air) are: ΔC₀=−1.44 pF, ΔC₁=1.89 fF, ΔL₁=−0.13 mH, and ΔR1=−0.0072 Ω. The changes in series resonant frequency, Δfₛ=−3481 Hz. There is no significant change in motional resistance R₁, before and after the antibody immobilization onto the gold surface of the quartz crystal, suggesting that the changes in resonant frequency due to antibody immobilization are predominantly caused by mass loading on the quartz crystal. After the resonant frequency fₛ of the immunosensor in buffer solution reaches a steady value (with variations of approximately ±3˜5 Hz min⁻¹), as described in the previous sections, the experiment for GABA binding measurement can be performed.

Once the acoustic immunosensor has been calibrated, measurements can be made using the working electrode. In one embodiment, measurements can be made by placing the anti-GABA-coated immunosensor in a PBS buffer solution containing GABA in a phosphate buffer. The equivalent circuit parameters can then be measured in situ during the immunological binding reaction.

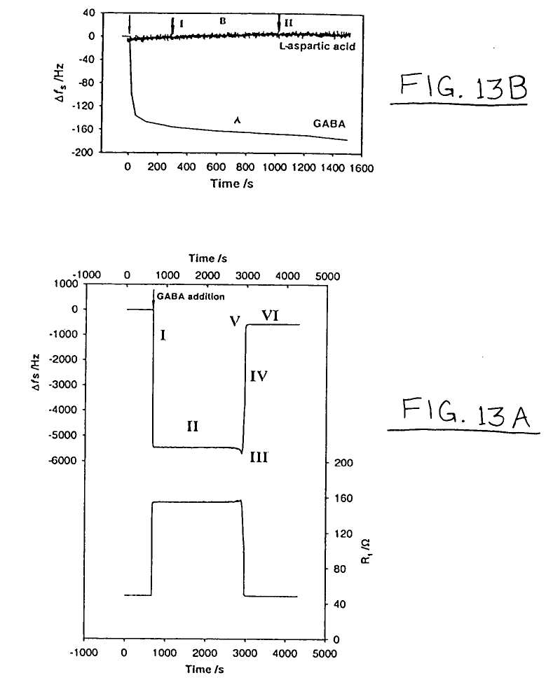

A chart showing the measured impedance parameters of an acoustic immunosensor in accordance with the practice of the present invention which is measuring 10 μl of M⁻³M GABA solution in a 5 ml phosphate buffer (p.H—7.4) is shown in FIG. 13A.

The time course of impedance responses of the immunosensor during GABA binding in phosphate buffer solution (PBS) is illustrated. The final GABA concentration in buffer is 38.0 μM. As soon as GABA solution is added, the series resonant frequency (Δfₛ) curve decreases sharply and then gradually reaches a steady value. Within the first 5 s of GABA addition, the frequency drops by 140 Hz and gradually reaches a steady value with a total change in resonant frequency of approximately 180 Hz. The immunosensor gave no significant response in R₁ (about 0.5 Ω increase, not shown here) when the GABA solution was added into the detector cell. Further, there was only 0.3 Ω increase in R₁ when the same amount of buffer solution is added. These results indicate that the immunosensor developed here can be specific to GABA binding in a buffer solution. Moreover, the smaller R₁ changes in GABA binding indicate that the “mass” effect plays a key role in the observed changes in resonant frequency.

The specificity of the acoustic immunosensor of the present invention against common neurochemical interferents like 1-aspartic acid, 1-glutamine, 1-alanine, 5-aminovaleric acid, glycine, (S)-(+)-2-aminobutyric acid is discussed below in relation to FIG. 13B. Embodiments of the acoustic can respond selectively to GABA but not to any of the interfering species mentioned above. For example, the response of the sensor to 1-aspartic acid is shown in 13B. The other interfering species aforementioned gave similar responses (not shown here) as 1-aspartic acid (in FIG. 13B). The response of the acoustic immunosensor to 38.0 μM GABA in the presence of the above interfering species was approximately the same as that in pure buffer solution. These results demonstrate the selectivity of the GABA immunosensor in PBS buffer solution. Further, the acoustic sensor did not respond to the addition of both 20 and 10 μl of PBS in liquid in control experiments.

Analysis

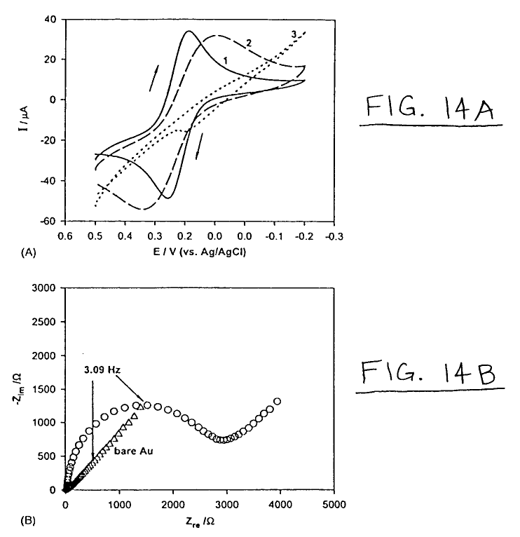

The electrochemical characterization of present patterned gold surface is shown in FIGS. 14A and 14B. In FIG. 14A, curve 1 represents the bare gold electrode, curve 2 represents the gold electrode after being coated with cystamine, curve 3 represents the electrochemical behavior after GABA binds on the gold electrode substrate. It is clear that the redox couple exhibits an irreversible electrochemical behavior on the modified gold electrode (curves 2 and 3). When the cystamine (or glutaraldehyde) binds to the gold surface, the access of this redox couple is greatly hindered (curve 2). Therefore, it can be anticipated that the formation of an antibody-antigen complex will change the electrochemical behavior because the electrode is coated with a barrier layer (curve 3). The smaller peak observed in the cathodic potential scan (curve 3) is accounted for by the electrochemical reduction of electroactive group on gold electrode. Furthermore, the cystamine layer assembled on a bare gold surface in this phosphate buffer shows no electrochemical redox peaks in the potential range shown.

As for EIS results, it is evident that the charge transfer resistance R_{ct} (as shown in FIG. 14B) measured on cystamine-coated gold electrode greatly increases. As the electrochemical reaction of a redox couple becomes increasingly hindered when electrode surface is coated with cystamine, the charge transfer resistance (R_{ct}) increases whereas the heterogeneous standard charge-transfer rate constant (k_{α}⁰) and the double-layer capacitance (C_{d}) will decrease accordingly. According to the EIS measured here, the electrochemical parameters obtained: for bare gold electrode are, k_{α}⁰=3.28×10.5 ms⁻¹, R_{ct}=334 Ω, R_{Ω}=4.78 Ω, and C_{d}=149.7 μF; for cystamine-coated gold electrode, k_{α}⁰=4.39×10⁻⁶ ms⁻¹, R_{ct}=2500 Ω, R_{□}=4.78 Ω, and C_{d}=20.6 μF.

The use of an acoustic wave based immunosensor to measure the adsorption process of anti-GABA protein in air and immuno-interaction of anti-GABA and GABA in liquid. In air, the antibody adsorption is comprised of several different processes as shown by the changes observed in the resonant frequency of the quartz crystal and the different electrical model parameters. These surface processes are primarily influenced by water incorporation and evaporation in the protein layer as shown by the equivalent circuit analysis. Based on the slope values of the equivalent circuit impedance parameters during these surface processes, the energy damping and dissipation of the shear acoustic wave into media have been determined. Furthermore, the contributions of “non-mass” effect on total resonant frequency changes are estimated in protein adsorption and binding reaction processes. The electrochemical behavior of the gold electrode indicates some irreversible changes after GABA binding reaction. The biomolecules-modified gold electrode was electrochemically characterized by CV and EIS methods. Changes in the electrochemical impedance parameters reflect the underlying biomolecular changes on the gold surface of the immunosensor before and after various surface modification procedures. The output of the piezoelectric impedance immunosensor provides a real-time and continuous measurement of GABA concentration. In other embodiments, the acoustic immunosensor can be used in biointerfacial reaction measurements and bioprocess monitoring.

In all of the methods described above, the chemicals described can be obtained from Sigma-Aldrich Co. of St. Louis, Mo. The chemicals used are preferably of analytical grade or better.

As is discussed above, the adsorption process of anti-GABA on an the surface of an electrode constructed in accordance with the present invention and the immuno-interaction between GABA and anti-GABA in liquid can be measured in real-time by a network analyzer and changes in the electrical equivalent circuit parameters (□f, C₀, R₁, L₁, C₁). These impedance parameters can be used to analyze changes in the interfacial viscoelastic properties during adsorption of liquid anti-GABA in air and during binding between GABA and anti-GABA in liquid phase. The detailed description, which is set forth above, in connection with the appended drawings is intended as a description of embodiments of the acoustic impedance immunosensor of the present invention and is not intended to represent the only forms in which the present invention may be constructed or utilized. It is to be understood, however, that the same or equivalent functions and steps may be accomplished by different embodiments, which are also intended to be encompassed within the spirit and scope of the invention.

1. A working electrode, comprising:
a layer of piezoelectric material;
at least one electrode layer fixed to the piezoelectric material; and
a bio-specific recognition layer formed on the electrode layer and including anti-GABA.

2. The working electrode of claim 1, wherein the piezoelectric material is a quartz crystal.

3. The working electrode of claim 2, wherein the electrode layer is constructed using gold.

4. An acoustic immunosensor, comprising:
an electrochemical cell, including a working electrode, comprising:
a layer of piezoelectric material;
at least one electrode layer fixed to the piezoelectric material; and
a bio-specific recognition layer formed on the electrode layer and including anti-GABA.
an electrochemical workstation connected to at least one electrode of the electrochemical cell; and
an impedance analyzer connected to the working electrode.

5. The acoustic immunosensor of claim 4, further comprising a personal computer connected to the electrochemical workstation and the impedance analyzer.

6. A method of detecting an amount of GABA, comprising:
coating a working electrode in a bio-specific recognition layer that includes anti-GABA;
determining the impedance properties of the working electrode in an electrochemical cell;
adding the GABA to the electrochemical cell;
determining the impedance properties of the working electrode in the presence of the GABA.

7. The method of claim 6, wherein the GABA is added to the electrochemical cell in a buffer solution.
